(19) United States
(12) Patent Application Publication
(10) Pub. No.: US 2007/0268528 A1
(43) Pub. Date: Nov. 22, 2007

(54) Multifunction Device

(75) Inventors: Takahiro Ikeno, Seto-shi (JP); Toshinari Watanabe, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/690,578

(22) Filed: Mar. 23, 2007

(30) Foreign Application Priority Data
Mar. 24, 2006 (JP) 2006084258

(51) Int. Cl. H04N 1/04

(52) U.S. Cl. 358/474

(57) ABSTRACT

A multifunction device includes an image scanning unit that scans an image on a sheet and creates a first file based on the scanned image, an interface that communicates with an external device and transmits and receives a second file to and from the external device, an image forming unit that forms on a recording sheet an image based on a target file selected from the first file and the second file, the image forming unit being arranged below the image scanning unit, a display, and a controller that controls the display to display a plurality of pieces of information in an arranged manner, the information including at least an image based on the target file.

### CROSS-REFERENCE TO RELATED APPLICATION

This application claims priority from Japanese Patent Application No. 2006-084258, filed on Mar. 24, 2006, the entire subject matter of which is incorporated herein by reference.

### TECHNICAL FIELD

Aspects of the present invention relates to a multifunction device.

### BACKGROUND

A multifunction device including a fax, a copier, a scanner, etc., has an operation key and a display. A user utilizes the operation key to carry out an operation and recognizes the operation state on the display. The multifunction device may simultaneously display a plurality of pages on a display.

For example, JP-A-H08-76648 discloses a copying machine including a display, on which a plurality of pages are previewed simultaneously.

However, according to JP-A-H08-76648, an image contained in a file is not an object of display. Further, a sheet such as an A size sheet or a B size sheet having a vertical-horizontal ratio of √2:1 or a letter size sheet having a vertical-horizontal ratio of 11:8.5 have been frequently used in general at offices, for example. Assume that an image scanning unit scans a plurality of documents each having a vertical-horizontal ratio of √42:1. If a plurality of pages of such image data are displayed to a maximum vertical width by means of a display with a related aspect ratio of 3:4 disclosed in JP-A-H08-76648, merely image data on one page and a part of image data on a second page may be displayed within a single screen. However, further images may not be displayed within a single screen. Further, images for two pages or more are not naturally displayed horizontally. In order to horizontally display images for two pages or more, it has been necessary to reduce the size of each image, which is to be displayed, based on the horizontal width of the display. However, if the display images are reduced in size, the display area is too small to recognize the images. Moreover, an unused region is formed at an upper part of the display. Thus, the effective utilization of the display is hardly achieved.

### SUMMARY

Aspects of the present invention provide a multifunction device that displays effective information concerning an image contained in a file on a display thereof. Aspects of the present invention also provide a multifunction device that can realize the effective utilization of a display.

### BRIEF DESCRIPTION OF THE DRAWINGS

FIG. 1 is a perspective view showing an exterior appearance of a multifunction device;

FIG. 2 is a perspective view showing the multifunction device in which a document cover is opened;

FIG. 3 is an exemplary block diagram of the multifunction device;

FIG. 4 is a partial plan view of an operation panel;

FIG. 5 is an exemplary program stored in a ROM;

FIG. 6 is an exemplary content confirmation display mode;

FIG. 7 is an exemplary overall confirmation display mode;

FIG. 8 is an exemplary double-sided image display;

FIG. 9 is an exemplary one-side image detailed display;

FIG. 10 is an exemplary image configuration;

FIG. 11 is a flowchart showing the overall operations; and

FIG. 12 is a flowchart subsequent to FIG. 11.

### DETAILED DESCRIPTION

<General Overview>

An aspect of the present invention provides a multifunction device comprising: an image scanning unit that scans an image on a sheet and crates a first file based on the scanned image; an interface that communicates with an external device and transmits and receives a second file to and from the external device; an image forming unit that forms on a recording sheet an image based on a target file selected from the first file and the second file, the image forming unit being arranged below the image scanning unit; a display; and a controller that controls the display to display a plurality of pieces of information in an arranged manner, the information including at least an image based on the target file.

Another aspect of the invention provides a multifunction device comprising: image scanning means for scanning an image on a sheet and creating a first file based on the scanned image; interface means for communicating with an external device and transmitting and receiving a second file to and from the external device; image forming means for forming on a recording sheet an image based on a target file selected from the first file and the second file, the image forming means being arranged below the image scanning means; display means; and control means for controlling the display means to display a plurality of pieces of information in an arranged manner, the pieces of information including at least an image based on the target file.

<Illustrative Aspects>

Hereinafter, an aspect of the present invention will be described with reference to the drawings.

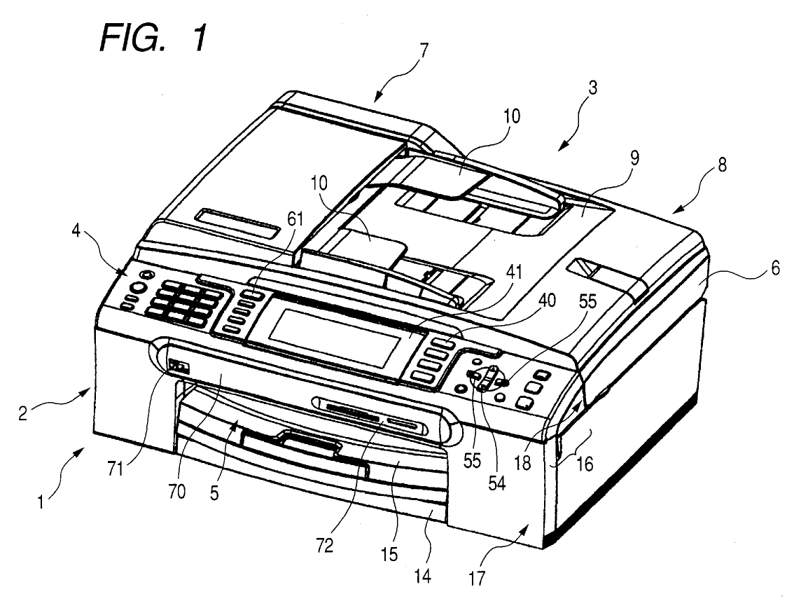

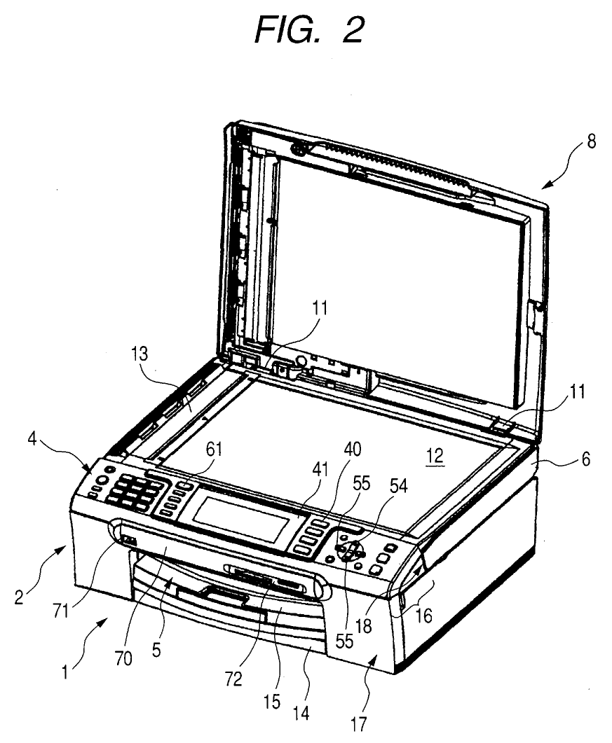

FIG. 1 is a perspective view showing an exterior appearance of a multifunction device (MFD) 1. FIG. 2 is a perspective view showing an exterior appearance of the multifunction device 1 in which a document cover 8 is opened. As shown in FIGS. 1 and 2, the multifunction device 1 integrally includes: a printer unit 2 provided at its lower part; a scanner unit 3 provided at its upper part; and an operation panel 4 provided on a front side of the scanner unit 3. That is, the multifunction device 1 has printer, scanner, copy and facsimile functions. Incidentally, the multifunction device 1 may have at least two functions.

In the scanner unit 3, the document cover 8 including an auto document feeder (ADF) 7 is attached to a document scanning table 6 such that the document cover 8 can be opened and closed via hinges 11 (see FIG. 2) arranged at a rear side of the scanner unit 3. The document scanning table 6 functions as a flatbed scanner (FBS). As shown in FIG. 2, a platen glass 12 is disposed at an upper face of the document scanning table 6, and an image scanning unit (not shown) is contained in an inner portion of the document scanning table 6.

The platen glass 12 has a substantially rectangular shape, in which a horizontal width of the platen glass is greater than a vertical width thereof such that being horizontally elongated in a plan view. In a plan view, the vertical width of the platen glass 12 corresponds to the short side of a letter size sheet, and the horizontal width of the platen glass 12 corresponds to the long side of an A4 size sheet. Therefore, an image on a letter size sheet and an image on an A4 size sheet can both be scanned.

An opening is formed at the upper face of the document scanning table 6, and the platen glass 12 is fitted into this opening. In the inner portion of the document scanning table 6, a space for allowing the movement of the image scanning unit, and a space for disposition of the image scanning unit or a member for supporting the unit and a mechanism for driving the unit, etc., are secured. Therefore, although the upper face of the document scanning table 6 is formed to be larger than the platen glass 12, the document scanning table 6 is formed to have a shape substantially similar to that of the platen glass 12 in a plan view. That is, similarly to the platen glass 12, the document scanning table 6 is horizontally elongated in a plan view and has a substantially rectangular parallelepiped shape having a predetermined height.

The image scanning unit includes a line image sensor whose main scanning direction corresponds to the depth direction of the multifunction device 1. The image scanning unit scans an image in the following manner. A light source emits light and irradiates the document with the light.

The ADF 7 conveys a document from a document tray 9 to a document discharge tray 10 through a document conveying path. In a document conveying process by the ADF 7, a document passes through a scanning surface 13 on the document scanning table 6, and an image of the document is scanned by the image scanning unit that is on standby below the scanning surface 13.

The printer unit 2 maybe a inkjet image forming unit (inkjet printer) which selectively discharges an ink drop based on image data file scanned at the scanner unit 3 or externally inputted image data file and forms an image on a recording sheet. As described above, this printer unit 2 is disposed below the scanner unit 3. Since the scanner unit 3 and the printer unit 2 are positioned such that the rear faces thereof are flush with each other, the rear face of the multifunction device 1 has a substantially flat shape. Incidentally, the inkjet system described above is one aspect of image forming system by the printer unit 2. Various image forming systems such as an electrophotographic system and a thermal transfer system may be adopted.

An opening 5 is formed at a front side of the multifunction device 1. In other words, the opening 5 is formed at a front side of the printer unit 2. A sheet feed tray 14 (equivalent to a casing for a recording sheet) and a sheet discharge tray 15 are provided in this opening 5. The sheet feed tray 14 and the sheet discharge tray 15 are disposed one above the other: the sheet discharge tray 15 is provided as the upper tray, and the sheet feed tray 14 is provided therebelow. The sheet feed tray 14 vertically contains rectangular recording sheets in a plan view. The horizontal width of the sheet feed tray 14 corresponds to the short side of a letter size sheet while the vertical width thereof corresponds to the long side of an A4 size sheet. Thus, both of a letter size sheet and an A4 size sheet can be used.

As described above, the document scanning table 6 is formed into a horizontally elongated parallelepiped. Thus, a front-side end face 17 of the printer unit 2 is protruded frontward from a front-side end face 18 of the scanner unit 3 by a predetermined width. Hereinafter, the front-side end of the printer unit 2, protruded frontward in this manner, will be called as a protrusion 16. It should be noted that the printer unit 2 is formed such that the horizontal width thereof corresponds to that of the scanner unit 3. Therefore, the multifunction device 1 is formed into an approximately square shape in a plan view.

As described above, the document scanning table 6 is formed to have a size that allows a letter size document to be horizontally placed, and the sheet feed tray 14 is formed to have a size that allows a recording sheet to be vertically placed. Thus, the protruded width of the protrusion 16 is approximately set at a width calculated by subtracting the short side of a letter size from the long side of an A4 size. In addition, the printer unit 2 is formed such that the horizontal width thereof corresponds to that of the scanner unit 3. Therefore, an empty space with a horizontally elongated parallelepiped shape is formed above the protrusion 16. Although described in detail later, the operation panel 4 of the multifunction device 1 is disposed in this empty space.

The printer unit 2 has a sheet conveying path that extends upward from the depth side of the sheet feed tray 14 and then bends frontward in a substantially U-shaped manner to be connected to the sheet discharge tray 15.

The operation panel 4 is provided at the front side of the multifunction device 1. The operation panel 4 has a substantially horizontally elongated shape as shown in FIGS. 1 and 2 and is fitted into the empty space arranged above the protrusion 16. In other words, the operation panel 4 is formed such that the vertical width thereof is not more than a length (vertical width of the empty space) calculated by subtracting the vertical width of the scanner unit 3 from that of the printer unit 2. The operation panel 4 is provided to allow the operations of the printer unit 2 and the scanner unit 3, and includes various operation keys 40 and a liquid crystal display (LCD) 41. A user can input a desired command by utilizing the operation panel 4. Upon input of a predetermined command to the multifunction device 1, a controller 20 controls the operation of the multifunction device 1 based on the inputted information. The specific configuration of the operation panel 4 will be described in detail later. Incidentally, system of the multifunction device 1 is configured such that the multifunction device 1 operates based on a command inputted from the operation panel 4, or the multifunction device 1 operates based on a command transmitted from the computer via a printer driver, a scanner driver, etc, when being connected to a computer.

A connection panel 70 is provided above the opening 5 of the printer unit 2. This connection panel 70 has a USB terminal 71 at its left side. The USB terminal 71 functions as a connector terminal that makes a USB connection with external equipment to enable communication between the external equipment and the multifunction device 1. Further, the connection panel 70 has a slot 72 at its right side. The slot 72 has a plurality of card slots into which a card type memory can be inserted. When a card type memory is inserted into the card slot and image data files are read from the inserted card type memory by the controller 20 described below, the read image data file and information concerning the image data file are displayed on the LCD 41 by the controller 20. The selected arbitrary image may be formed on a recording sheet at the printer unit 2.

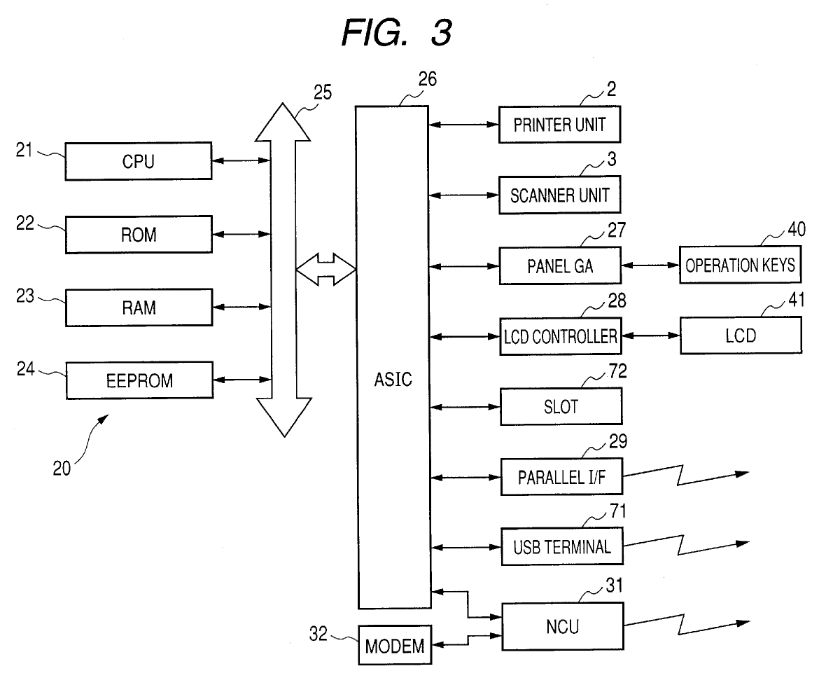

Hereinafter, a general configuration of the controller 20 for controlling the operation of the multifunction device 1 will be described with reference to a block diagram shown in FIG. 3. Herein, FIG. 3 is the block diagram showing the general configuration of the controller 20 of the multifunction device 1. The controller 20 carries out an overall control of the operation of the multifunction device 1 including the printer unit 2, the scanner unit 3 and the operation panel 4. As shown in FIG. 3, the controller 20 is configured as a microcomputer mainly composed of a central processing unit (CPU) 21, a read only memory (ROM) 22, a random access memory (RAM) 23 and an electrically erasable and programmable ROM (EEPROM) 24, and is connected to an application specific integrated circuit (ASIC) 26 via a bus 25.

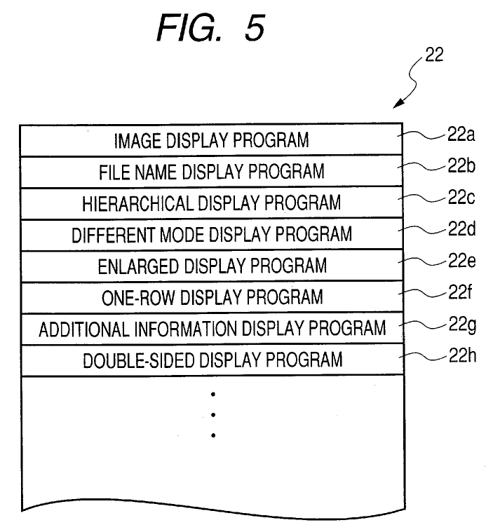

As shown in FIG. 5, the ROM 22 stores various programs such as an image display program 22a, a file name display program 22b, a hierarchical display program 22c, a different mode display program 22d, an enlarged display program 22e, a one-row display program 22f, an additional information display program 22g and a double-sided display program 22h. The image display program is a program for allowing at least one of a plurality of pieces of information which is displayed on the LCD 41 to become an image contained in a file. The file name display program 22b is a program for displaying the file name of a file in a first display region 58, and for displaying an image extracted from a file that has a file name and is selected from the displayed file names in a second display region 59. Further, the hierarchical display program 22c is a program for hierarchically displaying the file name of the files and the group name of a group to which this file name belongs in the first display region 58. The different mode display program 22d is a program for displaying the file name of a file in the first display region 58, and for displaying the file name of a file in the second display region 59 in a mode different from that of the first display region 58. The enlarged display program 22e is a program for displaying the whole of an image in the first display region 58, and for displaying an enlarged image of a portion selected from the whole of the image in the second display region 59. The one-row display program 22f is a program for displaying a plurality of the images arranged in a row on the LCD 41. The additional information display program 22g is a program for displaying a plurality of images along with additional information related to these images on the LCD 41. The double-sided display program 22h is a program for simultaneously displaying an upper-side image and a lower-side image of a double-sided document on the LCD 41. These programs are loaded into the RAM 23 and executed by the CPU 21.

A description will be made with reference to FIG. 3 again. ASIC 26 controls the operations of the printer unit 2, the scanner unit 3, the operation panel 4 and the slot 72 in accordance with a command from the CPU 21.

The ASIC 26 is connected with a panel gate array (panel GA) 27 for controlling the operation keys 40 through which a desired command is inputted to the multifunction device 1. The panel gate array 27 detects the pressing of the operation keys 40, and outputs a predetermined code signal. This key code is allocated to a plurality of the associated operation keys 40. Upon reception of a predetermined key code from the panel gate array 27, the CPU 21 carries out a control process which should be executed in accordance with a predetermined key process table. The key process table is tabulated by associating key codes with control processes and is stored in the ROM 22, for example.

The ASIC 26 is connected with an LCD controller 28 for controlling the screen display of the LCD 41. Based on a command from the CPU 21, the LCD controller 28 allows the LCD 41 to display, on its screen, information concerning the operation of the printer unit 2 or the scanner unit 3, a scanned image or an inputted image.

Further, the ASIC 26 is connected with a parallel interface 29 and the USB terminal 71 for exchanging data with a computer via a parallel cable or a USB cable. Furthermore, the ASIC 26 is connected with a Network Control Unit (NCU) 31 and a modem 32 for realizing a facsimile function.

Hereinafter, the operation panel 4 of the multifunction device 1 will be described in detail. As shown in FIGS. 1 and 2, the operation panel 4 is provided above the protrusion 16 of the printer unit 2. That is, the operation panel 4 is provided on the front side of the scanner unit 3. This operation panel 4 has the various operation keys 40 and the LCD 41.

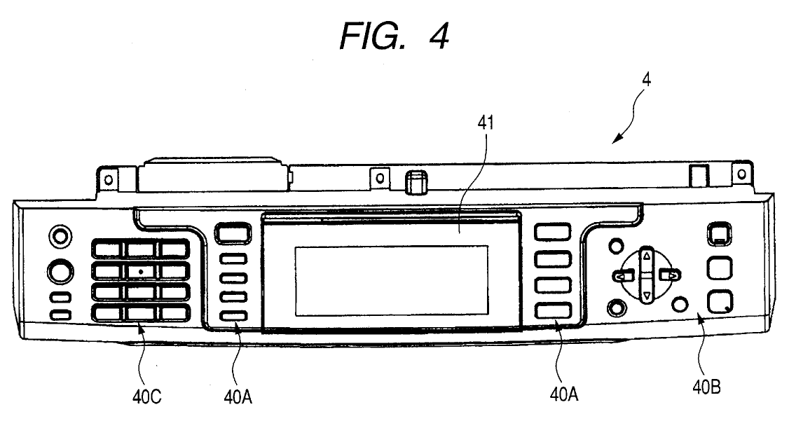

FIG. 4 is a partial plan view showing the configuration of the operation panel 4. As shown in FIG. 4, the LCD 41 is formed into a horizontally elongated rectangular shape in a plan view, and its vertical width (vertical dimension) is slightly smaller than the vertical dimension of the operation panel 4, but is substantially similar to the depth dimension of the operation panel 4. Therefore, the LCD 41 does not have space for allowing the operation keys 40 to be arranged in the operation panel 4 at its depth side and front side. In other words, the LCD 41 is increased in size to maximize its vertical width to the extent that the LCD 41 can be arranged in the operation panel 4.

As shown in FIG. 4, the LCD 41 is arranged in the center in the width direction of the operation panel 4. The width dimension of the LCD 41 is sufficiently smaller than that of the operation panel 4. Accordingly, on lateral sides of the LCD 41, spaces for allowing the operation keys 40 to be arranged in the operation panel 4 are ensured. When the LCD 41 is arranged in the center of the operation panel 4, the operation keys 40 can be arranged on both right and left sides of the LCD 41. Thus, the balance of the position of the LCD 41 with respect to the location of the operation keys 40 can be improved.

The operation keys 40 includes following three types: operation keys 40A provided around the LCD 41; operation keys 40B provided at a right end side of the operation panel 4; and operation keys 40C provided at a left end side of the operation panel 4. The operation keys 40A are arranged around the LCD 41 in a manner that columns of the operation keys 40A are arranged along lateral edges of the LCD 41 on both the right and left sides thereof. By allowing the operation keys 40A to be arranged on both the right and left sides of the LCD 41 in this manner, the spaces laterally existing in the LCD 41 can be effectively utilized.

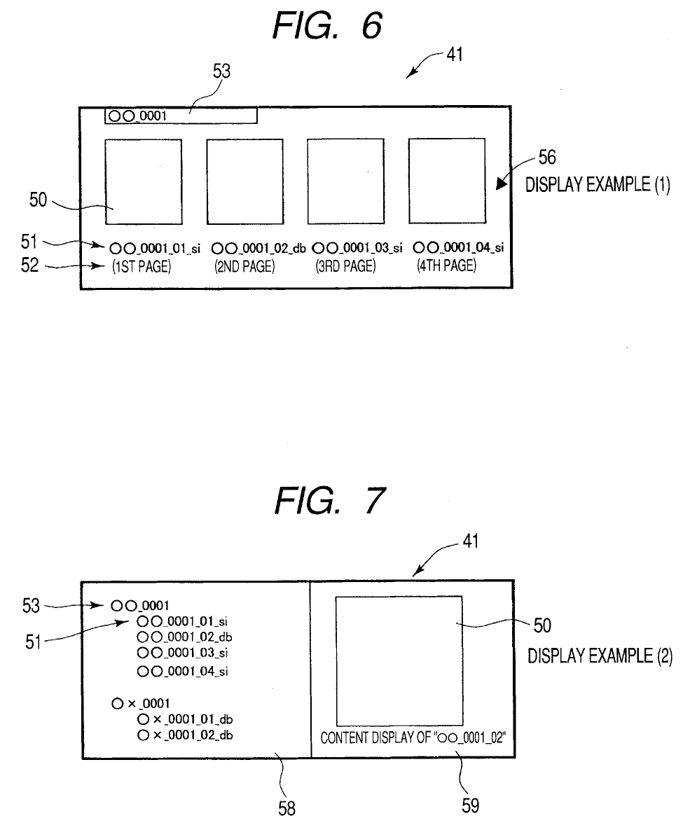

Display examples of the LCD 41 are shown in FIG. 6 through FIG. 9. These examples include the display of an electronic data of a received faxed document, the display of data scanned by the scanner unit 3, and the display of a file transmitted from a computer that is connected to the multifunction device 1. The display example shown in FIG. 6 illustrates a mode for confirming and displaying the content of a file (which will hereinafter be called a content confirmation display mode). As shown in this example, a plurality of pieces of information (e.g., images 50, file names 51, page numbers 52 and a group name 53) are displayed on the LCD 41. For example, the file name 51 of a first page is “OO_{—}0001_{—}01_si,” and the image 50 associated thereto is displayed over this file name 51. The content (image 50) of the filename 51 can be recognized at a glance by displaying the information in this manner. Further, in this aspect, the images 50 for four pages are displayed at one time. Thus, the display efficiency is high.

The LCD 41 has a ratio of its horizontal width to its vertical width is 4/3 or more and has a horizontally elongated shape. Therefore, as shown in FIG. 6, the images 50, which have been scanned from an A4 size or letter size document, can be vertically oriented and horizontally displayed in a row. Further, since the file names 51 and the page numbers 52 are displayed under the respective images 50 as described above, substantially no undisplayed region exists. Thus, the screen can be effectively utilized.

On the other hand, a right triangle mark 56 is displayed on the LCD 41. This mark is displayed when images for five or more pages exist. If right and left keys 55 (see FIGS. 1 and 2) are kept pushed rightward, the images for the fifth and the subsequent pages are displayed. If the images for the fifth and the subsequent pages are displayed, a left triangle mark (not shown) is displayed on the LCD 41. Thus, a user can immediately recognize the existence of the images 50 for the first through fourth pages.

The group name 53 is displayed at an upper portion of the LCD 41. All the images being displayed belong to this group. By operating upper and lower keys 54 (see FIGS. 1 and 2), the group name 53 is changed, and the images 50 belonging to another group are displayed.

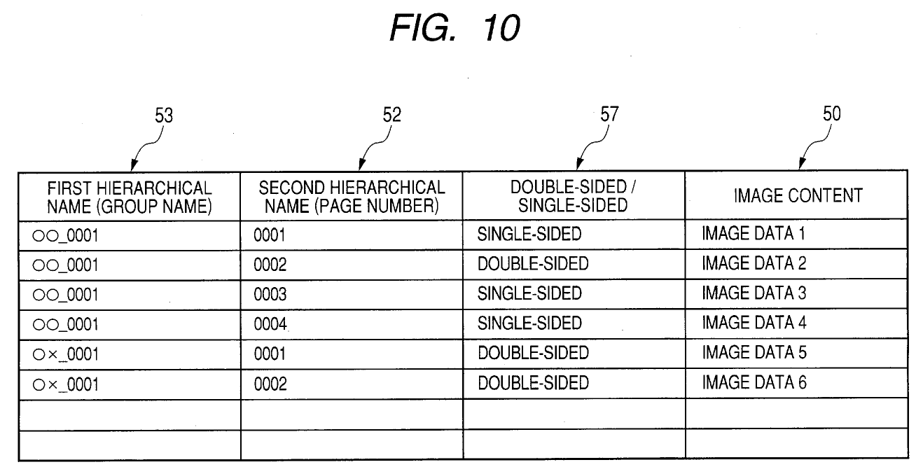

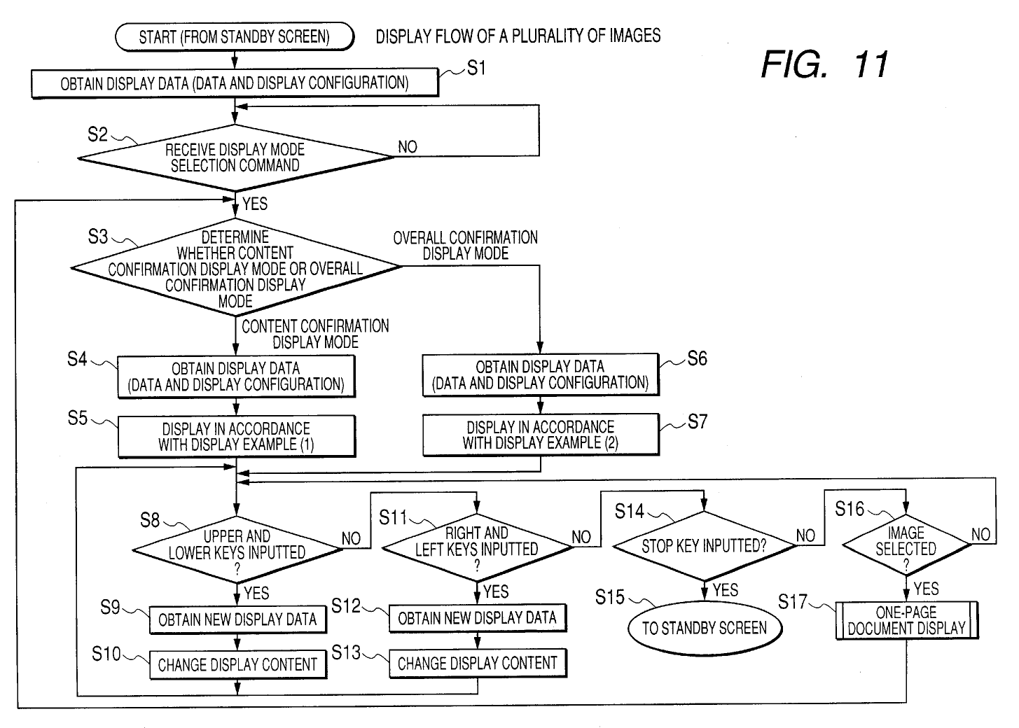

The structure of each file is shown in FIG. 10. As shown in FIG. 10, each file includes a first hierarchical name (group name 53), a second hierarchical name (page number 52), double-sided/single-sided information 57 and the image 50. In addition to the above pieces of information, the date, the time and the name of a transmitter are also stored for the faxed data. Furthermore, if the double-sided/single-sided information 57 is double-sided information, both of upper-side data and lower-side data are stored in the image 50. The above-described file names 51 (see FIG. 6) are each formed to include the group name 53, the page number 52 and the double-sided/single-sided information 57. For example, if the group name 53 is “OO_{—}0001,” the page number 52 is “01” and the double-sided/single-sided information 57 is single-sided (single) information, then the file name 51 becomes “OO_{—}0001_{—}01_si.” Similarly, if the double-sided/single-sided information 57 is double-sided (double) information, then the end of the file name becomes “db.”

Next, the display example shown in FIG. 7 will be described. This display is a mode for confirming the overall file configuration and the respective images 50 (which will hereinafter be called as overall confirmation display mode). In this display example, the LCD 41 is divided into the first display region 58 and the second display region 59, and the file content is displayed in a different mode in each region. More specifically, in the first display region 58, the file names 51 and the group names 53 are hierarchically displayed. Accordingly, a user can immediately recognize that four files including “OO_{—}0001_{—}01_si,” etc., exist within the group name 53 “OO_{—}0001.”

Moreover, by pressing the upper and lower keys 54 (see FIGS. 1 and 2) arranged in the operation panel 4, any one of the file names 51 can be selected. In the display example shown in FIG. 7, “OO_{—}0001_{—}02_db” is selected. On the other hand, in the second display region 59, the image 50 of the selected file is displayed. In the display example shown in FIG. 7, the image 50 can be displayed larger compared with the display example shown in FIG. 6. Therefore, fine lettering, etc., can be easily recognized.

If the upper and lower keys 54 are kept pushed downward, the display shifts to the next group name 53 “Ox_{—}0001.” If the upper and lower keys 54 are further kept pushed downward, the undisplayed group names 53 and file names 51 are displayed.

The LCD 41 is formed into a horizontally elongated shape (such that the ratio of its horizontal width to its vertical width is 4/3 or more) as described above. Therefore, when the LCD 41 is divided into the two display regions 58 and 59 as shown in FIG. 7, each of the display regions 58 and 59 can be enlarged. Thus, both the file names 51 and the image 50 can be enlargedly displayed, and the visibility is improved.

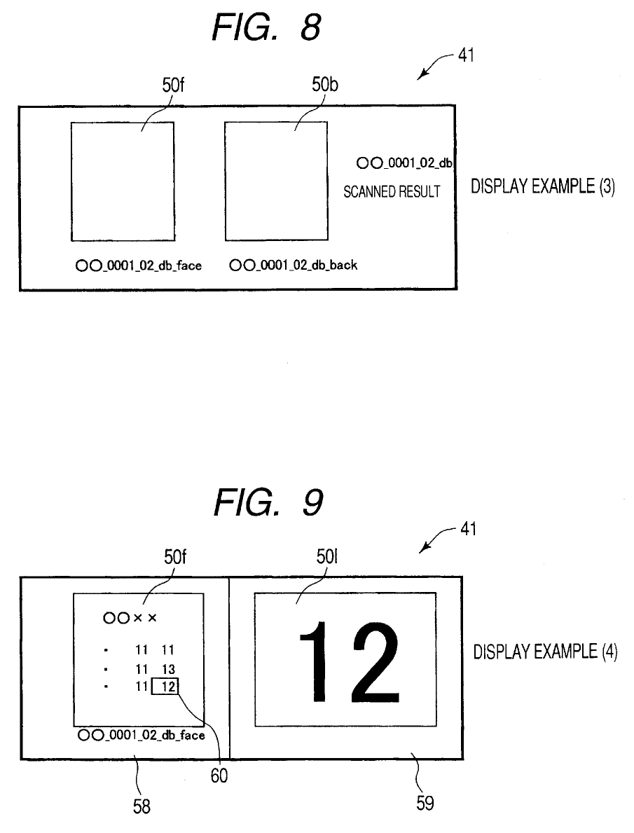

Next, the display example shown in FIG. 8 will be described. In this display example, an upper-side image and a lower-side image of a double-sided document are simultaneously displayed. An upper-side image 50f is displayed at the left side of the screen, and a lower-side image 50b is displayed at the right side of the screen. By simultaneously displaying both sides, it becomes easy to recognize the file content. For example, if fine lettering is displayed on the upper side and large lettering is printed on the lower side, a user can grasp the file content only by looking at the lower side.

Incidentally, in the display example shown in FIG. 8, the S file name of the upper side is “OO_{—}0001_{—}02_db_face.” Therefore, it is possible to recognize that this file name is associated with the upper side (face) at a glance. Furthermore, the file name of the lower side is “OO_{—}0001_{—}02_db_back.” Therefore, it is possible to recognize that this file name is associated with the lower side (back) at a glance likewise.

The LCD 41 is formed into a horizontally elongated shape (such that the ratio of its horizontal width to its vertical width is 4/3 or more) as described above. Therefore, the upper-side image 50f and the lower-side image 50b can be horizontally arranged and enlargedly displayed. Furthermore, the arranged images 50f and 50b will not be overlapped.

Next, the display example shown in FIG. 9 will be described. Also in this display example, the LCD 41 is divided into the first display region 58 and the second display region 59. The whole image (the image 50f) of a selected file is displayed in the first display region 58, and a selection display part 60 is displayed at a portion thereof. This selection display part 60 can be movably displayed by operating the upper and lower keys 54 and the right and left keys 55 (see FIGS. 1 and 2). On the other hand, the enlarged image (the image 501) of the selection display part 60 is displayed in the second display region 59. For example, even in the case where the content cannot be recognized by looking at the whole image because the lettering is small, it is possible to recognize the content by looking at the enlarged display.

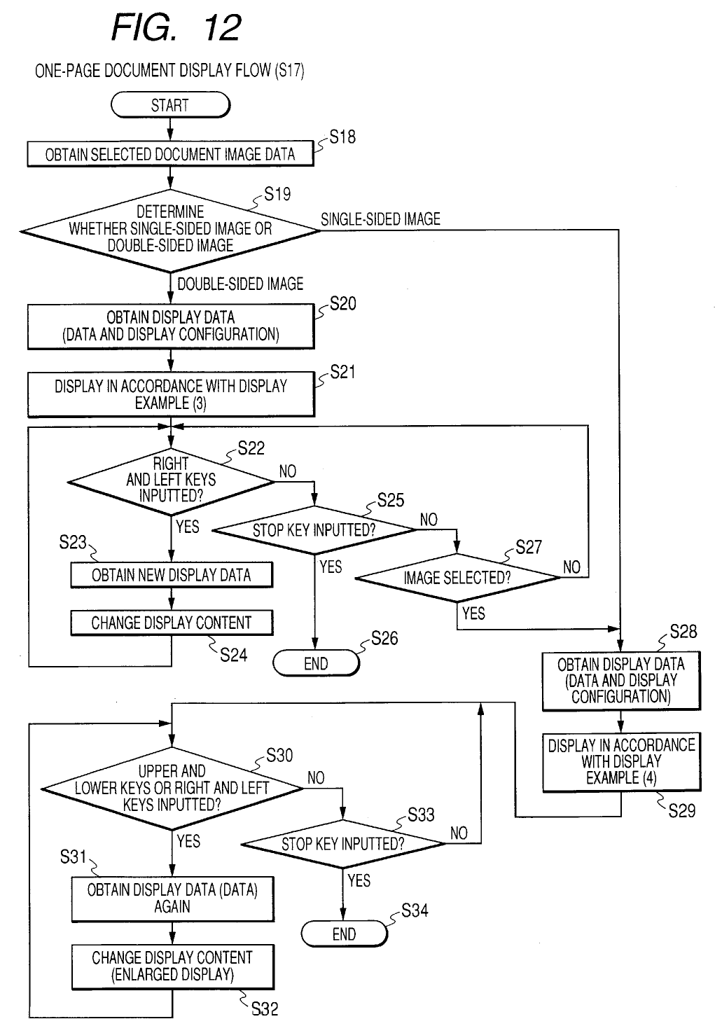

Next, referring to flowcharts shown in FIGS. 11 and 12, description will be made about the operations of the programs. First, in Step S1, display data (data and display configuration) are obtained. For example, the display data are obtained as a result of data transmission by a fax, image scanning by a scanner and data transmission from a computer. Then, the process moves to Step S2 in which a user selects a display mode. In this step, a user operates the operation panel 4, and thus the content confirmation display mode (FIG. 6) or the overall confirmation display mode (FIG. 7) is selected to be displayed on the LCD 41. Accordingly, a selection command (for selecting the content confirmation display mode or the overall confirmation display mode) is issued. If the issued selection command is received (if the answer is YES), the process moves to Step S3, and this selection command is identified in Step S3. If the command for selecting the content confirmation display mode is identified in Step S3, the process moves to Step S4 in which the associated display data are obtained, and are then displayed on the screen in accordance with the format shown in FIG. 6 (Step S5). On the other hand, if the command for selecting the overall confirmation mode is identified in Step S3, the process moves to Step S6 in which the associated display data are obtained and are then displayed on the screen in accordance with the format shown in FIG. 7 (Step S7).

Next, the process moves to Step S8 in which it is determined whether the upper and lower keys 54 are inputted. In this step, if it is determined that the upper and lower keys 54 are inputted (if the answer is YES), the process moves to Step S9 in which new display data are obtained. Then, the display content is changed in Step S10. For example, if the upper and lower keys 54 are pressed when the content confirmation display mode (FIG. 6) is displayed, the group name 53 is changed from “OO_{—}0001” to “Ox_{—}0001,” and the image 50 belonging to this group is displayed on the LCD 41. On the other hand, if the upper and lower keys 54 are pressed when the overall confirmation display mode (see FIG. 7) is displayed, the file name 51 being selected is vertically moved, and the selected image 50 is displayed in the second display region 59. The processes of Steps S8 through S10 correspond to these display operations.

If the answer is determined to be NO in Step S8, the process moves to Step S11 in which it is determined whether the right and left keys 55 are inputted. If it is determined that the right and left keys 55 are inputted (if the answer is YES) in this step, the process moves to Step S12 in which new display data are obtained. Then, the display content is changed in Step S13. For example, it the right and left keys are pressed when the content confirmation display mode (FIG. 6) is displayed, the image 50 being selected is moved right and left. Furthermore, if the images 50 for the fifth and the subsequent pages exist, the images 50 for the fifth and the subsequent pages are displayed by keep pushing the right and left keys 55 rightward. The Steps S11 through $13 correspond to these display operations.

On the other hand, if the answer is determined to be NO in Step S11, the process moves to Step S14 in which it is determined whether a stop key is inputted. If the stop key is inputted, a standby screen is displayed (Step S15). On the other hand, if the stop key is not inputted, the process moves to Step S16 in which it is determined whether an image is selected. If a user presses a determination key 61 (see FIGS. 1 and 2) of the operation panel 4, the image 50 is selected, and the process of Step S17 is started.

FIG. 12 shows the detailed flowchart of Step S18 and the subsequent steps. First, in Step S18, selected image data are obtained. In Step S19, it is determined whether the image is a single-sided image or double-sided image. If the image is the double-sided image, the process moves to Step S20 in which display data (data and display configuration) are obtained and are then displayed in accordance with the format shown in FIG. 8 (Step S21). Next, the process moves to Step S22 in which it is determined whether the right and left keys 55 are inputted. If the right and left keys 55 are inputted (if the answer is YES), new display data are obtained in Step S23, and the display content is changed in Step S24. As a result, if the right and left keys 55 are pressed in the display example shown in FIG. 8, for example, the selection of the upper-side image 50f and the lower-side image 50b is switched.

If the answer is NO in Step S22, the process moves to Step S25 in which it is determined whether the stop key is inputted. If the answer is YES in this step, the process is ended (Step S26). If the answer is No, the process moves to Step S27 in which it is determined whether an image is selected. If a user presses the determination key 61 (see FIGS. 1 and 2) of the operation panel 4, the image 50 is selected and the answer in Step S27 becomes YES so that the process proceeds to Step S28.

On the other hand, if the image is determined to be the single-sided image in Step S19, the processes skips Steps S20 through S27 and moves to Step S28. In Step S28, display data (data and display configuration) are obtained Thereafter, the image display is carried out in accordance with the format shown in FIG. 9 (Step S29).

Then, the process moves to Step S30 in which it is determined whether the upper and lower keys 54 or the right and left keys 55 are inputted. If the upper and lower keys 54 or the right and left keys 55 are inputted (if the answer is YES), the process moves to Step S31 in which display data are obtained again. Then, the display content is enlargedly displayed in Step S32. As a result, if the upper and lower keys 54 and the right and left keys 55 are inputted in the display example shown in FIG. 9, the selection display part 60 is movably displayed, and the enlarged view thereof is displayed in the second display region 59.

If the answer is NO in Step S30, the process moves to Step S33 in which it is determined whether the stop key is inputted. If the answer is YES, the process moves to Step S34 in which the process is ended. If the answer is NO, the process returns to Step S30.

As described so far, the multifunction device 1 of the present invention at first allows a user to determine which one of the content confirmation display mode shown in FIG. 6 and the overall confirmation mode shown in FIG. 7 is displayed (Step S3) and to select the target image 50 by using these display modes (steps S8 through S16). If the selected image 50 is double-sided data, the display displays as shown in FIG. 8 (Steps S20 through S27). If the selected image 50 is single-sided data, the display displays as shown in FIG. 9 and an enlarged image can be viewed (Steps S28 through S32). That is, a user is allowed to display the target image 50 by using the content confirmation display mode or the overall confirmation mode, and is allowed to determine which one of the upper-side and the lower-side is displayed in the case of double-sided data, thus the enlarged display is subsequently made possible. Accordingly, it becomes possible to understand the content by enlarging the image in this manner even if the letter in the whole image 50 displayed on the LCD 41 is small.

In the multifunction device 1 of the present invention, only a required page can be selected and printed from data transmitted via a fax. Moreover, only a desired page can be selected then printed or faxed from data scanned by the scanner unit 3.

What is claimed is:

1. A multifunction device comprising;
an image scanning unit that scans an image on a sheet and creates a first file based on the scanned image;
an interface that communicates with an external device and transmits and receives a second file to and from the external device;
an image forming unit that forms on a recording sheet an image based on a target file selected from the first file and the second file, the image forming unit being arranged below the image scanning unit;
a display; and
a controller that controls the display to display a plurality of pieces of information in an arranged manner, the pieces of information including at least an image based on the target file.

2. The multifunction device according to claim 1,
wherein the controller controls the display to display on a first display region file names of files, the files including the target file, and
wherein the controller controls the display to display on a second display region an image extracted from a file having a file name selected from among the file names displayed in the first display region.

3. The multifunction device according to claim 2,
wherein the controller controls the display to hierarchically display on the first display region the file names of the files and a group name of a file group to which the files belong.

4. The multifunction device according to claim 1,
wherein the controller controls the display to display on a first display region an information related to the target file, and
wherein the controller controls the display to display on a second display region the information related to the target file in a mode different from that of displayed in the first display region.

5. The multifunction device according to claim 4,
wherein the information includes a file name, an image and data for determining whether the image is of a double-sided type or of a single-sided type.

6. The multifunction device according to claim 4,
wherein the controller controls the display to display on the first display region a whole image based on the target file, and
wherein the controller controls the display to display on the second display region an enlarged image of a region selected from the whole image of the file.

7. The multifunction device according to claim 1,
wherein the controller controls the display to display a plurality of images in a row.

8. The multifunction device according to claim 7,
wherein the controller controls the display to further displays additional information related to each of the images.

9. The multifunction device according to claim 1,
wherein the controller controls the display to simultaneously display a first image and a second image that are contained in the target file, the first image corresponding to a front face of a sheet of a document, and the second image corresponding to a back face of the sheet of the document.

10. The multifunction device according to claim 1,
wherein the image forming unit and the image scanning unit are arranged such that a first direction, in which the image forming unit forms the image on the recording sheet, intersects with a second direction, in which the image scanning unit scans the image from the read medium.

11. A multifunction device comprising:
image scanning means for scanning an image on a sheet and creating a first file based on the scanned image;
interface means for communicating with an external device and transmitting and receiving a second file to and from the external device;
image forming means for forming on a recording sheet an image based on a target file selected from the first file and the second file, the image forming means being arranged below the image scanning means;
display means; and
control means for controlling the display means to display a plurality of pieces of information in an arranged manner, the pieces of information including at least an image based on the target file.
